(19) United States
(12) Patent Application Publication
(10) Pub. No.: US 2007/0120830 A1
(43) Pub. Date: May 31, 2007

(54) Rotatable touchpad and angle of rotation sensor

(76) Inventor: Bernhard Kämmerer, Taufkirchen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/583,492

(22) PCT Filed: Sep. 7, 2004
(86) PCT No.: PCT/EP04/52069

§ 371 Date: Jun. 15, 2006

(30) Foreign Application Priority Data
Dec. 15, 2003 (DE) 10358700.4

(51) Int. Cl. G09G 5/00

(52) U.S. Cl. 345/173

(57) ABSTRACT

A device comprises a rotatably supported touchpad, especially on the steering wheel of a motor vehicle, means for measuring an angle of rotation of the touchpad in relation to a reference system, and means for processing inputs into the touchpad taking into consideration the measured angle of rotation.

At the international automobile exhibition in 2003 in Frankfurt, Siemens AG showed a touchpad which is installed in the center console of a motor vehicle, recognizes a driver's handwriting and converts it into commands for a multimedia system of the vehicle. The system integrates a circular touchpad into the surface of a tactile feedback button.

The disadvantage of this solution is that left handers in cars adapted to right-hand traffic or right handers in cars adapted to left-hand traffic find that the touchpad arranged on the center console is on the wrong side and thereby find it practically impossible to make inputs on it.

The object of the invention is to make a more flexible arrangement of the touchpad possible.

This object is achieved by the inventions specified in the independent claims. Advantageous embodiments are shown in the dependent claims.

Accordingly, a device comprises a rotatably supported touchpad, means for measuring an angle of rotation of the touchpad in relation to a reference system, and means for detecting inputs made on the touchpad taking into account the angle of rotation measured.

This allows the touchpad to be arranged in a motor vehicle on the vehicle's steering wheel without a corrupted signal being delivered and thereby the input not being successfully detected when the wheel is turned. The write position on the steering wheel can be easily reached by the driver in any event.

Compared to a mechanical decoupling of the touchpad from the steering wheel position and simultaneous central positioning of the touchpad in the middle of the steering wheel the proposed solution is more cost-effective and superior from the safety standpoint as regards accident protection and airbag.

The touchpad is supported rotatable by being arranged on the steering wheel.

In particular, the touchpad is arranged on the horn button of the steering wheel arranged over an airbag.

Preferably the touchpad is arranged on the steering wheel so that an imaginary extension of the steering column passes through it.

The touchpad, meaning in particular its touch-sensitive surface, is preferably circular in shape. In this case the central point of the touchpad, that is especially of the circle, lies at least approximately on the axis around which the touchpad can be rotated, and the normal to the touchpad surface is at least approximately parallel to this axis.

The device advantageously comprises means for handwriting recognition which recognizes handwritten inputs on the touchpad. In particular, the means for handwriting recognition are means for letter recognition which solely detect individual letters and characters. Thus, the computing effort for recognition can be reduced and the surface of the touchpad can be kept small in accordance with the input of individual letters and characters.

For example, commands, place names, street names and/or names for controlling a stereo system, a multimedia center and/or a navigation system can be input via the touchpad.

The touchpad can comprise means for outputting haptic outputs and/or responses.

As an alternative or in addition the touchpad is formed as a touchscreen and comprises display means for outputting optical indications. The optical indications are or include in particular optical responses, for example the input path traced by the user's finger on the touchpad. Especially advantageously the optical indications are output taking into account the measured angle of rotation so that, for example, the elements displayed on the touchpad remain still even if the touchpad is rotated.

A vehicle, especially an automobile, with an inventive device is especially advantageous. If the motor vehicle is already equipped with an electronic steering, its sensors can be used simultaneously as a means for measuring the angle of rotation of the touchpad in relation to the motor vehicle.

Embodiments of a method emerge in a similar way to the embodiments of the device and vice versa.

Further features and advantages of the invention emerge from the description of an exemplary embodiment with reference to the drawings. The drawings show:

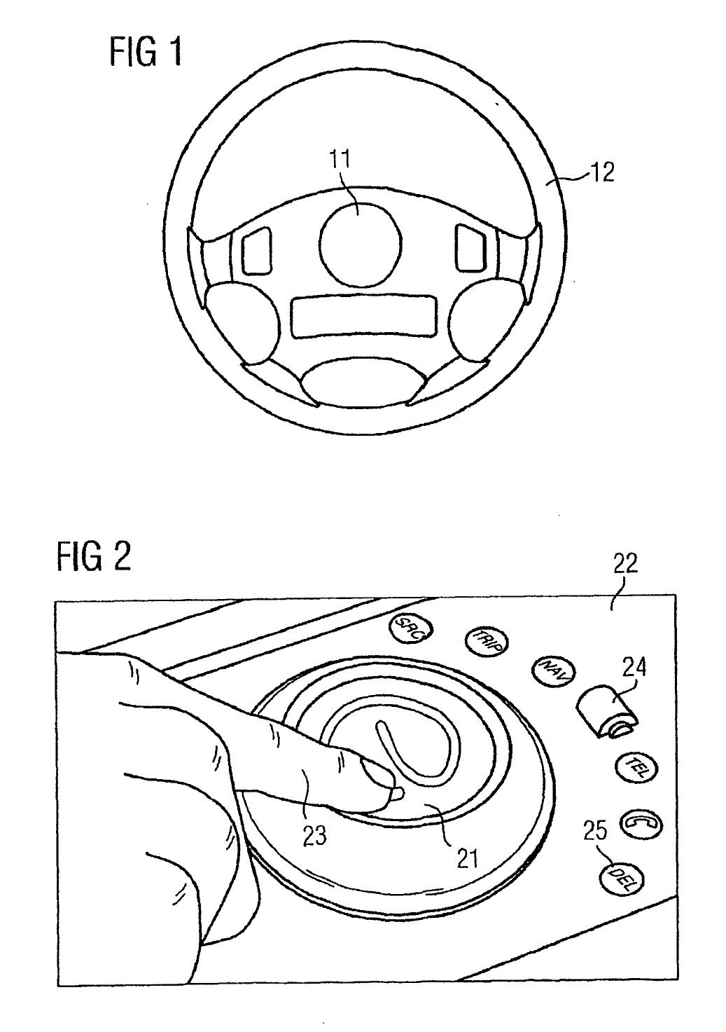

FIG. 1 a steering wheel with a touchpad;

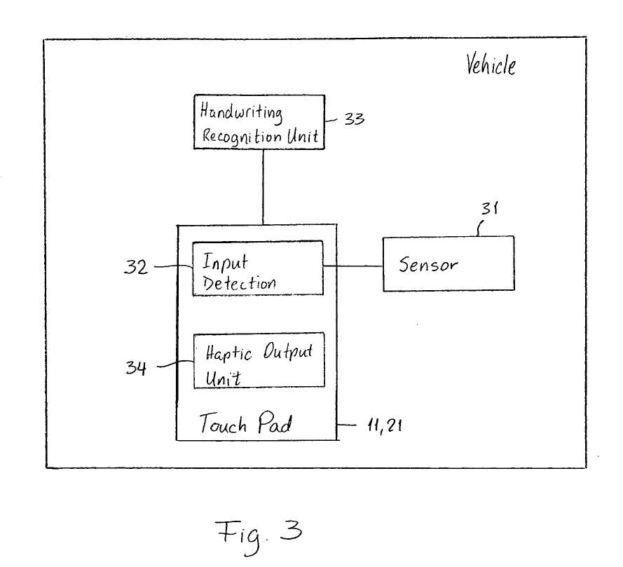

FIG. 2 an alternative touchpad on the horn button of another steering wheel in detail.

The invention allows handwritten input, for example by using a finger, on a touchpad (digitization panel, pad) mounted on a steering wheel. The handwritten input of letters in the motor vehicle can for example be used for entering destinations for navigation or for recording messages, such as SMS messages or e-mails.

With the aid of the touchpad, the position of the input instrument that is the finger, for example, is converted at a point in time t into x(t)/y(t)coordinates, meaning that it is digitized and transferred as a time sequence to a classification system. In the case of a classification system for handwritten characters, this classification system assigns to a sequence of coordinates a specific character class, which in turn serves as input for a subsequent device which is, for example, a navigation device and/or a communication device.

The invention makes provision for an electronic correction of the input, taking into account the deflection of the steering wheel. To this end the position of the steering wheel is continuously electronically recorded. This signal is used for the conversion of the digitized coordinates x(t) and y(t) into rotation-position corrected coordinates x′(t), y′(t) which, for example, are fed to a handwriting recognition system.

FIG. 1 shows a circular touchpad 11 which is arranged centrally in the direction of an extension of the steering column on the horn button of the steering wheel 12.

FIG. 2 shows an alternative embodiment with a touchpad 21 which is arranged on the horn button 22 of a steering wheel. A letter “e” was written with a finger 23 on the touchpad 21. In the immediate vicinity of the touchpad 21 a scroll wheel 24 and six pushbuttons are arranged on the horn button 22 of the steering wheel, with which the vehicle, the multimedia system and/or navigation system can be controlled as a supplement to the touchpad 21.

The following ergonomic and economic advantages are attained by the invention:
easy-to-reach writing position,
suitable both for left handers and for right handers,
no different variants required for right-hand traffic and left-hand traffic vehicles
simple mechanics.

1.-13. (canceled)

14. A device for electronically detecting and processing input instructions, comprising:
a touchpad,
means for measuring an angle of rotation of the touchpad in relation to a reference system,
means for detecting inputs into the touchpad, and
handwriting recognition means for recognizing handwritten inputs into the touchpad taking into account the measured angle of rotation.

15. The device of claim 14, wherein the reference system is a motor vehicle.

16. The device of claim 15, further comprising a steering wheel on which the touchpad is arranged.

17. The device of claim 16, wherein the touchpad is arranged on the horn button of the steering wheel.

18. The device of claim 16, wherein the touchpad is arranged on the steering wheel in a direction of an imaginary extension of a steering column.

19. The device of claim 14, wherein the touchpad is circular.

20. The device of claim 14, wherein the handwriting recognition means are adapted to recognize commands and names input via the touchpad.

21. The device of claim 14, wherein the touchpad comprises means for outputting haptic responses.

22. The device of claim 14, wherein the touchpad comprises display means for outputting optical indications.

23. The device of claim 22, wherein the display means is adapted to output the optical indications taking into account the measured angle of rotation.

24. A motor vehicle having a device for electronically detecting and processing input instructions, the device comprising:
a touchpad,
means for measuring an angle of rotation of the touchpad in relation to a reference system,
means for detecting inputs into the touchpad, and
handwriting recognition means for recognizing inputs into the touchpad taking into account the measured angle of rotation.

25. The motor vehicle of claim 24, wherein the reference system is the motor vehicle.

26. The motor vehicle of claim 25, further comprising a steering wheel on which the touchpad is arranged.

27. The motor vehicle of claim 26, further comprising an electronic steering which includes the means for measuring the angle of rotation of the touchpad in relation to the motor vehicle.

28. A method of electronically detecting and processing input instructions, comprising the steps of:
providing a device comprising a touchpad, means for measuring an angle of rotation of the touchpad in relation to a reference system, means for detecting inputs into the touchpad, and handwriting recognition means for recognizing handwritten inputs into the touchpad,
rotating the touchpad,
measuring the angle of rotation of the touchpad in relation to the reference system, and
processing handwritten inputs in the touchpad taking into account the measured angle of rotation.
